(19) United States
(12) Patent Application Publication
(10) Pub. No.: US 2012/0078522 A1
(43) Pub. Date: Mar. 29, 2012

(54) SYSTEMS AND METHODS FOR HOLISTIC ANALYSIS AND VISUALIZATION OF PHARMACOLOGICAL DATA

(75) Inventors: Gopal Avinash, Waukesha, WI (US); Zhongmin Lin, Waukesha, WI (US); Ananth P. Mohan, Waukesha, WI (US); Ricky R. Wascher, Brookfield, WI (US)

(73) Assignee: General Electric Company, Schenectady, NY (US)

(21) Appl. No.: 13/102,880

(22) Filed: May 6, 2011

Related U.S. Application Data
(60) Provisional application No. 61/386,876, filed on Sep. 27, 2010.

(51) Int. Cl. G06F 19/00

(52) U.S. Cl. 702/19

(57) ABSTRACT

Certain examples provide systems and methods for holistic viewing to provide comparative analysis and decision support in a drug development process. An example method includes accessing data related to drug development; pre-processing the data to prepare the data for measurement and analysis; and analyzing the data based on at least one of a plurality of different metrics. Each metric corresponds to a quantified variation between a first data set of results corresponding to a category in the drug development process. The first data set of results is provided for comparison with a second data set of results corresponding to at least one other category in the drug development process. At least some of the plurality of metrics are aggregated to generate a visual representation representing an integrated comparative visualization for the identified category.

### RELATED APPLICATIONS

The present application claims the benefit of priority from U.S. Provisional Patent Application No. 61/386,876, filed on Sep. 27, 2010, and entitled “Systems and Methods for Holistic Analysis and Visualization of Pharmacological Data”, which is incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND

Pharmaceutical drug development involves significant initial investment for a lengthy development and testing cycle resulting in a new compound coming to market between two to twelve years after initial discovery. Drug development typically includes a plurality of phases including exploratory research, a research phase, a pre-clinical research and development phase, a clinical research and development phase, a product registration and approval phase, and (possibly) a post-marketing phase after the compound is available for sale.

Drug development involves a large amount of data and analysis and evaluation of a compound's effect on a subject in pre-clinical studies and clinical trials. A plurality of sample populations and/or interactions may be tested under a variety of conditions. Resulting pre-clinical and clinical data are integrated into a new drug application (NDA) for submission to a regulatory agency, such as the Food and Drug Administration (FDA).

### BRIEF SUMMARY

Certain examples provide systems and methods for holistic viewing to provide comparative analysis and decision support in a drug development process. An example method includes accessing data related to drug development; pre-processing the data to prepare the data for measurement and analysis; and analyzing the data based on at least one of a plurality of different metrics. Each metric corresponds to a quantified variation between a first data set of results corresponding to a category in the drug development process. The first data set of results is provided for comparison with a second data set of results corresponding to at least one other category in the drug development process. At least some of the plurality of metrics are aggregated to generate a visual representation representing an integrated comparative visualization for the identified category.

An example holistic analysis and viewing system to support pharmaceutical drug development includes a standardizer, a deviation analyzer, and an output. The standardizer is to process (e.g., standardize and/or normalize, etc.) data related to drug development. The deviation analyzer is to analyze the data based on at least one of a plurality of different metrics. Each metric corresponds to a quantified variation between a first data set of results corresponding to an identified category in the drug development process. The first data set of results is provided for comparison with a second data set of results corresponding to at least one other identified category in the drug development process. The output is to aggregate at least some of the plurality of metrics to generate a visual representation representing an integrated comparative visualization for the identified category. The integrated comparative visualization is to enable a user to observe an outcome represented by at least some of the plurality of different metrics considered collectively to generate a visual report.

An example tangible computer-readable storage medium includes executable instructions for execution using a process. The instructions, when executed, provide a holistic analysis and viewing system to support a drug development process. The system includes a standardizer, a deviation analyzer, and an output. The standardizer is to process (e.g., standardize and/or normalize, etc.) data related to drug development. The deviation analyzer is to analyze the data based on at least one of a plurality of different metrics. Each metric corresponds to a quantified variation between a first data set of results corresponding to an identified category in the drug development process. The first data set of results is provided for comparison with a second data set of results corresponding to at least one other identified category in the drug development process. The output is to aggregate at least some of the plurality of metrics to generate a visual representation representing an integrated comparative visualization for the identified category. The integrated comparative visualization is to enable a user to observe an outcome represented by at least some of the plurality of different metrics considered collectively to generate a visual report.

### BRIEF DESCRIPTION OF SEVERAL VIEWS OF THE DRAWINGS

FIG. 1 is a block diagram of an example system to analyze normalized pharmaceutical test or trial data.

FIG. 2 illustrates a flow diagram for an example data mining and learning machine analysis flow.

FIG. 3 illustrates a flow diagram for an example holistic viewer-enabled analysis flow.

FIG. 4 illustrates a flow diagram for an example method for drug classification using a holistic viewer.

FIG. 5 illustrates an example generic depiction of a holistic data classification interface.

FIG. 6 shows a more specific example of a classification interface.

FIG. 7 depicts an example interface to provide holistic views and clustering for a plurality of patients.

FIG. 8 depicts example time-based views provided for longitudinal analysis.

FIG. 9 illustrates an example pharmacokinetic curve using in holistic viewing and analysis.

FIG. 10 illustrates an example holistic view of drug reference parameters over a plurality of test runs using a continuous coded representation for visualization.

FIG. 11 depicts an example clinical data flow.

FIGS. 12-15 depict example holistic viewers providing visual feedback with respect to pharmacological data.

FIG. 16 is a block diagram of an example processor system that can be used to implement the systems, apparatus and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, at least one of the elements in an at least one example is hereby expressly defined to include a tangible medium such as a memory, DVD, CD, Blu-ray, etc. storing the software and/or firmware.

Certain examples provide holistic analysis and visualization of pharmacological data. Certain examples provide holistic visualization and analysis of local features extracted from user-selected clinical regions of interest. Certain examples provide holistic data visualization and related applications in a pharmacological viewer.

A holistic approach to data, such as pharmacological data, can be used to bring diverse types of data together in one application for viewing and analysis. A holistic view and analysis can be used as part of a pharmaceutical testing and drug delivery process. The holistic view and analysis can be used to replace and/or supplement a data mining approach.

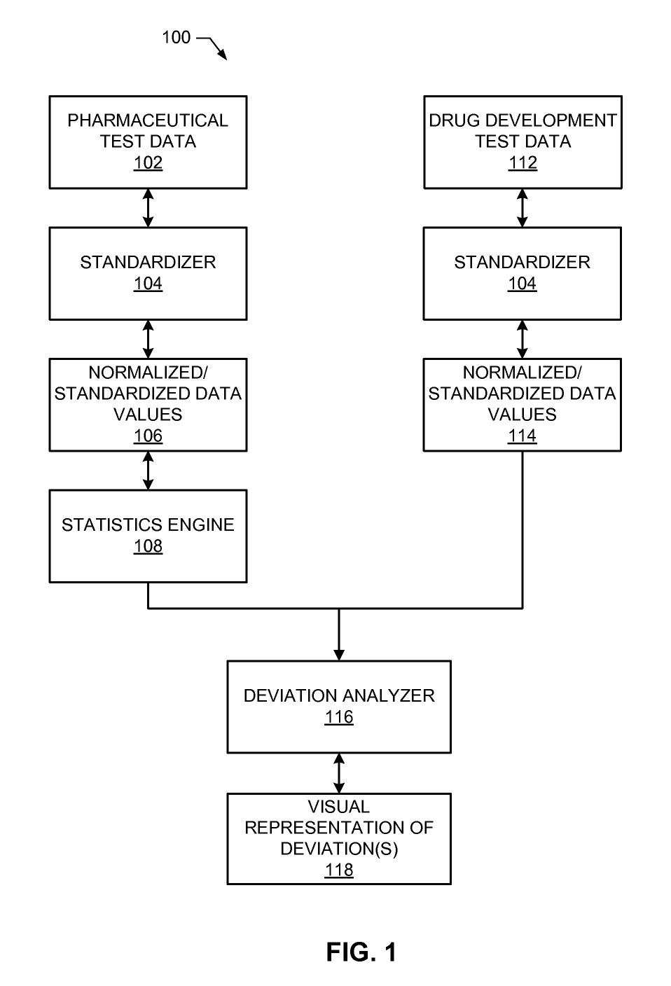

FIG. 1 is a block diagram of an example system 100 to analyze normalized pharmaceutical test or trial data. The system 100 gathers pharmaceutical data and creates descriptors that define a normal state or result which can be used to identify abnormal states and/or varying results in one or more chemical compounds, patients, test subjects, and/or other research/trial conditions, for example.

The system 100 includes pharmaceutical test data 102 with respect to a “normal”, control, reference, or expected value. The normal pharmaceutical test data 102 is acquired from one or more tests or projections involving drug compounds, test subjects, etc., identifying desired effects, concentrations, limitations, etc., in a proposed drug.

The pharmaceutical test data 102 is received by a standardizer 104 that normalizes and/or standardizes the pharmaceutical test data 102, thus generating normalized and/or standardized pharmaceutical data 106 of a plurality of normal subjects. The system 100 also includes a statistics engine 108 that determines statistics 110 of the normalized and standardized metadata 106 of the normal subjects. The statistics engine 108 operates on the normalized and/or standardized metadata 106 of each pharmaceutical test. The system 100 creates descriptors that define a normal, reference, or control state that can be used to identify abnormal states/results in drug development data.

The system 100 includes drug development test data 112 and/or other data related to a pharmaceutical drug development process. The drug development test data 112 is received by a standardizer 104 that normalizes and/or standardizes the drug development test data 112, thus generating normalized and/or standardized drug development test data 114.

In certain examples, data 106 and/or 112 can be standardized and normalized for one or more subjects. Then, an average of the data is determined A database or other data set of control and/or reference data, for a particular matched subject/criteria group, can be created. The data set can be criterion(-ia) specific and include mean and standard deviation data for normal/expected/control subject data sets. A well-defined “normal” cohort can be used to create a data set of normal/control/reference data. The set of normal cohort are clinically tested to determine the normal data information. In the standardized space, each label can be assigned a mean value and associated standard deviation based on the data samples from the cohort of normal cases. Drug development test data can be similarly standardized and normalized. Thereafter, a comparison of each of number of labels in the normalized subject data set and the drug development test data set is performed. A visual output of the comparison is generated.

Thus, a normal/reference/control/expected data set can be created using a standardization/normalization transformation of individual data values pertaining to all labels in all axes. In addition, a statistical metric can be established that is used to determine individual label-based abnormalities. A deviation from a reference, control, or expected vale can be displayed in a visual manner to facilitate a holistic view of result(s).

The system 100 also includes a deviation analyzer 116 that determines deviation(s) 118 between the reference or control statistic(s) 110 and the drug development test data 114 for each pharmaceutical test.

In an example, deviation(s) between data sets can be determined according to the following equation:

$$Δ {a}_{i} = \frac{{α}_{i} - {μ}_{ai}}{{σ}_{ai}} . \qquad Equation 1$$

In Equation 1, αᵢ is the i^{th} label of axis “a” and μᵢₐ and σₐᵢ. Equation 1 is applied to all the labels in all the axes and the resultant is a deviation data “vector”. Equation 1 is also known as the Z-score, standard score, or normal score, for example.

In certain examples, to determine deviation(s) in pharmacological data, available data is converted to a common unit of measurement (e.g., by the standardizer 104). Where the data being analyzed is represented in various units of measurement, determining a deviation includes converting the data to one particular unit of measurement in order to avoid a mathematically invalid deviation.

In certain examples, a deviation analysis includes label value-by-label value comparison of each clinical-test label in the drug development data to a corresponding clinical-test label in the comparison of the drug development test data and the control or reference subject data. Each clinical-test label belongs to a clinical category in the drug development test data, for example.

In certain examples, a deviation data vector is determined that describes how far the drug development test data deviates from the data to which it is being compared.

An output, such as a display, can generate a visual graphical representation of the deviation(s) 118 for each of the pharmaceutical test(s). Thus, system 100 helps identify and determine drug characteristics, drug effects, drug dosage, patient impact, and/or other data relevant to pharmaceutical drug development when compared against a cohort of normal controls using a structured approach based on a comprehensive data.

In certain examples, a visual representation of deviation for each drug development test provides drug development evaluation in a holistic and visual form. Deviation data can be displayed in a consistent and visually acceptable sense that may allow for improved drug development as the information is presented to the visual cortex of the brain for pattern matching rather than the memory recall based on computer-generated data mining.

One illustrative example is that all the data is ordered in a consistent from (ordering using clinical relevance is best) where the rows represent the axes and the columns represent each label within that axis. Each active pixel of this graph is assigned a color from a color scale that maps the deviation value of the label to a conspicuous concern value. A practitioner can see a pattern of deviation in conjunction with a relative degree of concern in one snapshot for a variety of axes and data. The visual depiction helps allow for a more rapid and consistent evaluation, for example.

In certain examples, visualization of data deviation includes generating Z-score table representations of the drug development deviation data. A table format representation shows a deviation from normal/control/reference and Z-scores. The table can be represented in graphical image format as well to provide a snap-shot of all deviation data for quick review to identify abnormal conditions/results.

In certain examples, rather than comparing drug development test results to reference, control, or expected values, one group or cohort of drug development test results is compared to another group of drug development test results to visualize conformity(ies) and/or deviation(s) between the two sets of test results.

Certain examples can identify variations in available data, such as pharmaceutical drug development data, and allow a user to visualize the data with respect to a reference (such as using the system 100 above). Using visualization of data deviation, a user does not need to be an expert to see deviation from a normal or reference value as an indication of an abnormal result.

In certain examples, drug development data and associated processing/analysis can be color-coded and/or otherwise differentiated to help a user visualize areas that are different from “normal”, expected, or reference value(s). Patterns, such as concentrations or “hot spots”, in the data can be quickly visualized and appreciated by a user, for example. Additionally, in certain examples, while patterns and/or abnormalities can be visualized, other details are not lost when displaying available data to a user.

In certain examples, a view of drug development data over time can be provided. A view can provide a representation of longitudinal trends in the data over time. For example, a deviation in one patient or test subject's longitudinal trends from a reference population or cohort can be tracked and visualized over time.

In certain examples, a distribution (e.g., one time and/or longitudinal over time) of drug data can be processed and visualized by taking a group of patients, candidates, etc., and comparing the group as a whole. Characteristics such as drug characteristics, disease signatures, symptoms, side effects, etc., can be viewed to determine how they deviate from a control group. Patterns identified from these view(s) can be fed back into the drug development process, for example. Characteristics of a reference versus a target can be visualized and evaluated on an individual and/or group basis, for example.

For pharmacological analysis, each metric examined can compare target data to a reference, for example. A plurality of metrics can be combined and presented in a single report. An analysis can be conducted any phase of the drug development process. For example, potential clinical trial or study candidates can be identified via a holistic visualization and review. Subject responses from candidates can also be reviewed and analyzed. Clinical trial results can be processed and visually depicted for user review. In addition or group or population-based analysis, drug compound test data, drug characteristics, etc., can be visually depicted and analyzed with respect to a reference or control, for example. In certain examples, data mining applied in pharmaceutical drug development can be supplemented or replaced by holistic viewing systems and methods described herein.

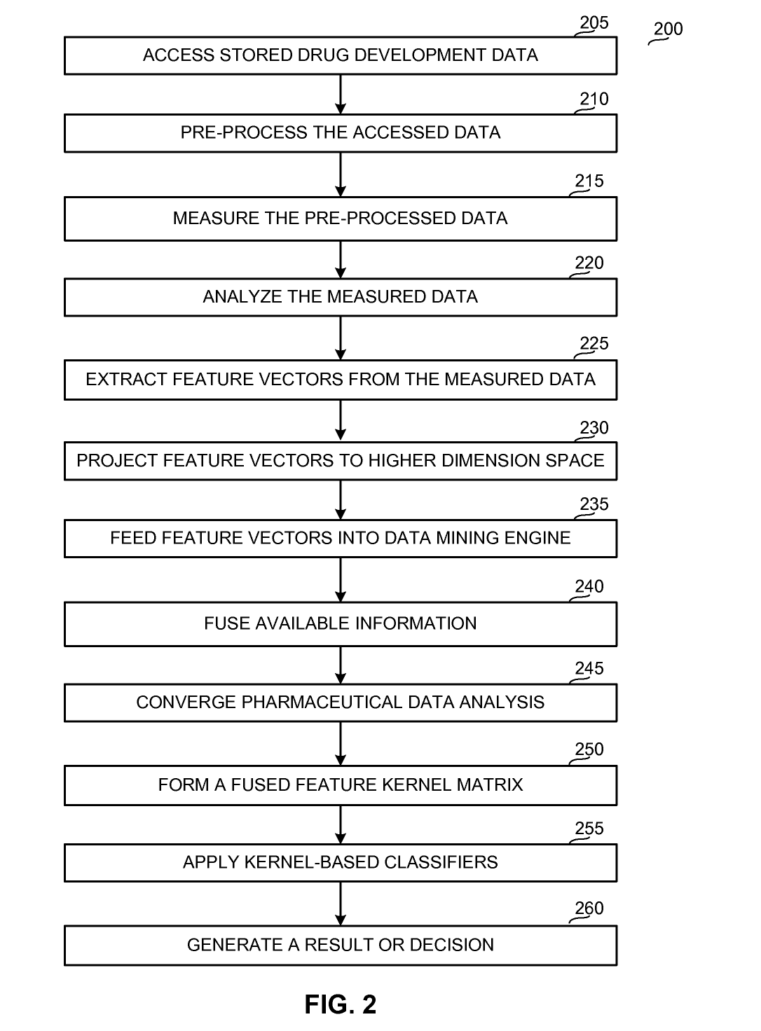

FIGS. 2-4 are flow diagrams representative of example machine readable instructions that may be executed to implement example systems and methods described herein, and/or portions of one or more of those systems (e.g., systems 100 and 1100) and methods. The example processes of FIGS. 2-4 can be performed using a processor, a controller and/or any other suitable processing device. For example, the example processes of FIGS. 2-4 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example processes of FIGS. 2-4 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example processes of FIGS. 2-4 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 2-4 can be implemented manually or as any combination(s) of any of the foregoing techniques, for example, any combination of firmware, software, discrete logic and/or hardware. Further, although the example processes of FIGS. 2-44 are described with reference to the flow diagrams of FIGS. 2-4, other methods of implementing the processes of FIGS. 2-4 can be employed. For example, the order of execution of the blocks can be changed, and/or some of the blocks described can be changed, eliminated, sub-divided, or combined. Additionally, any or all of the example processes of FIGS. 2-4 can be performed sequentially and/or in parallel by, for example, separate processing threads, processors, devices, discrete logic, circuits, etc.

FIG. 2 illustrates a flow diagram for an example data mining and learning machine analysis flow 200. At 205, stored data associated with pharmaceutical drug development is accessed. For example, data including pharmaceutical compound model(s); pharmacodynamic data; pharmacokinetic data; absorption, distribution, metabolism, and excretion (ADME) data; toxicity data; drug safety profile data; dosage data; side effect data; etc., can be accessed for processing, viewing, and analysis.

At 210, pre-processing is performed on the accessed data. Pre-processing can include, for example, data corrections, selection of one or more subsets of data, normalization of data relative to a reference or threshold, etc. At 215, the data is measured. For example, the pre-processed data is measured to extract quantitative information in relation to one or more of the accessed types of data.

At 220, the measurement data is analyzed. For example, at 225, data analysis can include extracting feature vectors from the measurement data. Thus, a drug can be represented by a vector representative of chemical structure including frequency of small fragments and/or frequency of labeled paths to classify chemical compounds. At 230, analysis can include projecting the feature vectors into a higher dimensional space (e.g., using a support vector machine (SVM)). At 235, analysis can also include feeding the feature vectors into a data mining (DM) engine. At 240, analysis can include fusion of the available information. In certain examples, features can be weighted based on relevant domain knowledge (e.g., knowledge of a pharmaceutical data domain).

At 245, pharmaceutical data analysis is converged. Convergence includes, for example, at 250, forming a fused feature kernel matrix from a plurality of available feature kernels (e.g., feature vector(s), SVM output(s), DM output(s), etc. At 255, kernel-based classifiers (e.g., (SVM, linear discriminant analysis (LDA), principal component analysis (PCA), nearest neighbor (NN), etc.) are applied to the fused feature kernel matrix. In certain examples, a kernel function can be selected based on one or more preferences, parameters, priorities, and/or circumstances to process and obtain a better or more optimal fused kernel. At 260, convergence includes generating a result or decision based on the kernel-based classification.

In certain examples, parameters can be improved or optimized using one or more training algorithms. Training and pharmaceutical test data sets can be separated, for example. Training prior to data mining can help improve selection of the right classifier for the available pharmaceutical data.

However, data mining methods can introduce difficulty when performing integrated quantifiable comparative analysis and decision support during a pharmaceutical drug development process. In addition, automated data mining techniques and applications can provide useful results but are hard to adequately prove in a regulated environment. Automated data mining techniques can also suffer limitations when encountering samples with missing data, noise in the data, and datasets too small for statistical significance or confidence.

Several differences are provided between a holistic viewer (HV) and a data mining or learning machine (DM/LM) approach. For example, a transformation of data differs between data mining and a holistic approach. In DM/LM, the transformation is to a feature vector space. In HV, the transformation is to a homogenizing space, such as a deviation from a reference value.

Training also differs between HV and DM/LM. For example, in DM/LM, training involves manual tweaking parameters of classifiers by a scientist/engineer. In HV, no training is required. Further, no data reduction is needed with a holistic view. In DM/LM, testing is accomplished by a trained classifier engine. In HV, testing is done by having a user understand overall patterns displayed in the data. While an end user in DM/LM only reviews the results, an end user (e.g., a clinician) in HV is directly involved in analyzing results and patterns in the data.

The HV provides output in a visual form, wherein relationships among various variables can be displayed and directly understood by the user. All forms of data are transformed to a common, consistent visual form. A Holistic Viewer approach provides an alternate or supplemental technique that keeps a human user involved and participating in the pharmacological data analysis process.

Certain examples utilize holistic views to visualize abnormality in medical (e.g., pharmaceutical) data by transforming raw results with respect to reference datasets (such as deviation from “normal” cohorts). Individually standardizing and normalizing clinical results enables the concurrent visualization of multi-disciplinary medical data and reveals characteristic disease signatures and abnormality patterns in specific patients or patient populations under review. Using a holistic viewer helps to improve, enhance and further enable comparative analysis during various stages in the development process of a pharmaceutical drug including discovery, clinical development and post-launch activities, for example.

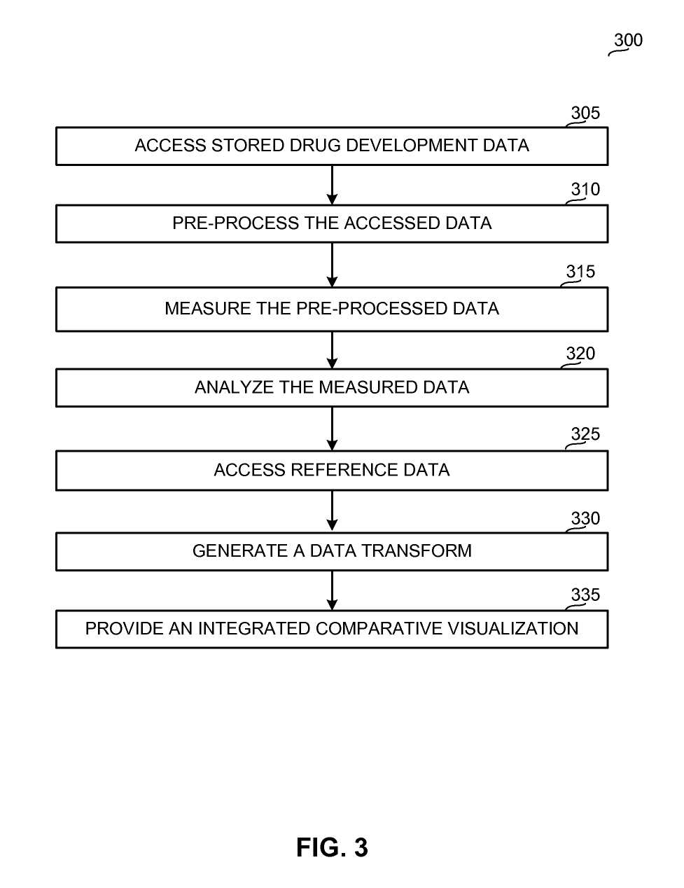

FIG. 3 illustrates a flow diagram for an example holistic viewer-enabled analysis flow 300. At 305, stored data associated with pharmaceutical drug development is accessed. For example, data including pharmaceutical compound model(s); pharmacodynamic data; pharmacokinetic data; absorption, distribution, metabolism, and excretion (ADME) data; toxicity data; drug safety profile data; dosage data; side effect data; etc., can be accessed for processing, viewing, and analysis.

At 310, pre-processing is performed on the accessed data. Pre-processing can include, for example, data corrections, selection of one or more subsets of data, normalization of data relative to a reference or threshold, etc. Pre-processing can leverages data that is fed into data mining and automated analytics processes, for example

At 315, the data is measured. For example, the pre-processed data is measured to extract quantitative information. At 320, the measurement data is analyzed. For example, at 325, data analysis can include accessing reference data (if applicable). At 330, a data transform is generated. For example, a transformation can involve a distribution analysis (e.g., a one-time distribution, a longitudinal distribution over time, etc.), a deviation with respect to a reference, etc.

At 335, an integrated comparative visualization of the analyzed data is provided. For example, a deviation map (e.g., a color-based or “heat” map) of comparative drug development data can be provided to a user for review. Using the data visualization, a user can arrive at result and/or decision, for example. Using a holistic approach to analysis of pharmacological data and visualization of the results helps keep the user involved and aware of a range of test and/or other results, for example.

In certain examples, a visual report is generated by method(s) and/or system(s) for integrated quantifiable comparative analysis and decision support in a pharmaceutical drug development process. The report utilizes and includes a plurality of different metrics. Each metric corresponds to a distinct quantified variation between a first data set of results corresponding to an identified category in the drug development process. The first data set of results is provided for comparison with a second data set of results corresponding to at least one other distinct category. At least some of the plurality of metrics are aggregated to generate a visual representation representing an overall outcome for the identified category. At least some of the plurality of metrics are used to observe an overall outcome represented by the plurality of different metrics when considered collectively to generate the visual report therefrom.

A holistic view can be used at a plurality of stages in a drug development process. For example, a holistic viewer can be applied during drug discovery. Pharmaceutical data classification can be facilitated using the holistic viewer. Holistic classification can be applicable in drug discovery, clinical trials, and/pr product efficacy analysis, for example.

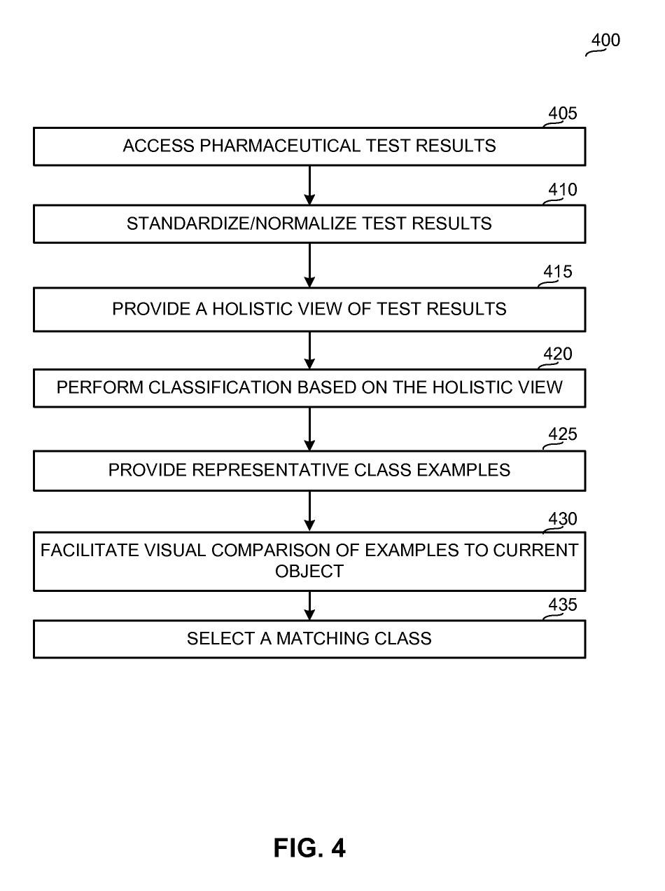

FIG. 4 illustrates a flow diagram for an example method 400 for drug classification using a holistic viewer. At 405, pharmaceutical test results are accessed.

At 410, test results are processed to standardize and/or normalize the data. For example, results can be standardized and/or normalized according to a reference value, threshold, normal, range, etc. At 415, a holistic view of the test results is provided. For example, a holistic view provides a graphical or visual depiction of variation in the test results with respect to the reference value, normal, threshold, range, etc. At 420, classification is performed based on the holistic view. For example, results data can be classified according to a particular phase of drug development. Data can be classified based on visual clustering, variation, and/or other visually appreciable grouping of data, for example.

At 425, representative examples of classes corresponding to each of the desired groups are provided. For example, groups for pharmaceutical cases can include patient cohorts, drugs, tests, disease types, disease severities, etc. For example, classes for a disease type of Alzheimer's disease can include normal, mild cognitively impaired (MCI), Alzheimer's disease, etc. Classes for a drug development can include one or more outcomes, reactions, concentrations, etc. Classes are used in classification of available data.

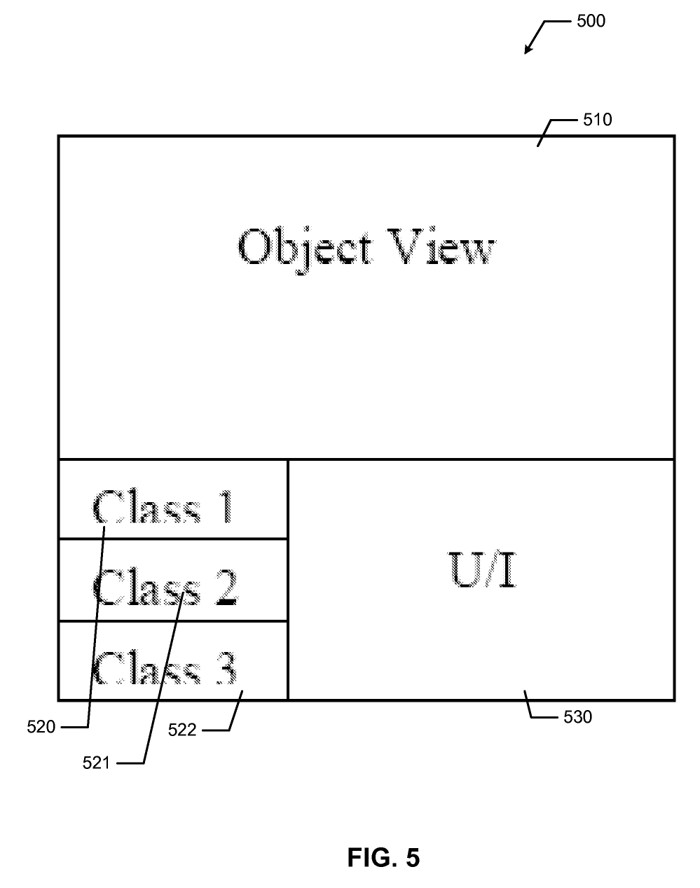

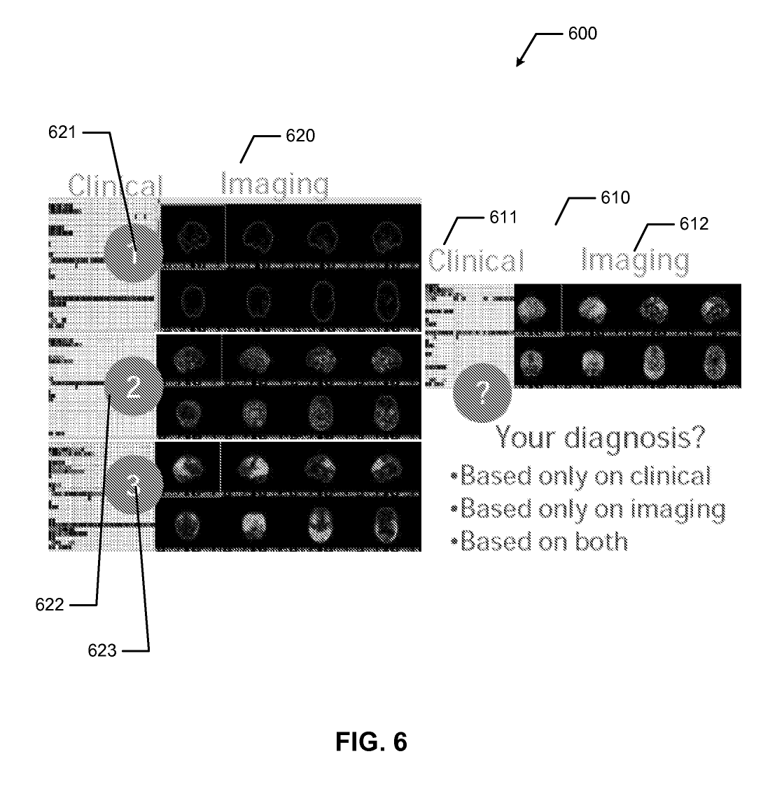

At 430, the representative examples are visually compared with a current object. A comparison can be used to classify data, for example. For example, a generic view 500 is provided in FIG. 5. A specific example view 600 is shown in FIG. 6. At 435, a class of the most matching representative examples is selected as the class of the current object.

FIG. 5 illustrates an example generic depiction of a holistic data classification interface 500. The interface 500 includes an object view 510, one or more classifications 520-522, and a user interface 530. The object view 510 provides a view of available data, which can be compared by a user against one or more classes 520-522 of representative data. The user interface 530 allows a user to manipulate the data, the classifications, and/or provide a diagnosis and/or further instruction, for example. Via the user interface 530, a user can indicate which class 520-522 best fits the data presented in the object view 510.

FIG. 6 shows a more specific example of a classification interface 600. In the interface 600, available clinical 611 and imaging 612 data are shown in an object view 610 window. Available classifications 620 include a normal classification 621, a mild cognitive impairment classification 622, and an Alzheimer's disease classification 623 shown via the interface 600. A user can select an appropriate classification 620 based on clinical information 611, imaging information 612, and/or a combination of clinical and imaging information 611, 612, for example. Similarly, a user can select a drug response based on a view of available data in comparison to classifications of drug responses, disease characteristics, other relevant indicators, etc.

Certain examples can be used to provide clustering using a holistic viewer. Clustering is similar to classification, but there are some differences. For example, a clustering process does not have pre-determined classes but rather has options to create as many ad hoc classes as needed that seem to be related. For example, test results can be grouped together based on one or more pre-determined themes.

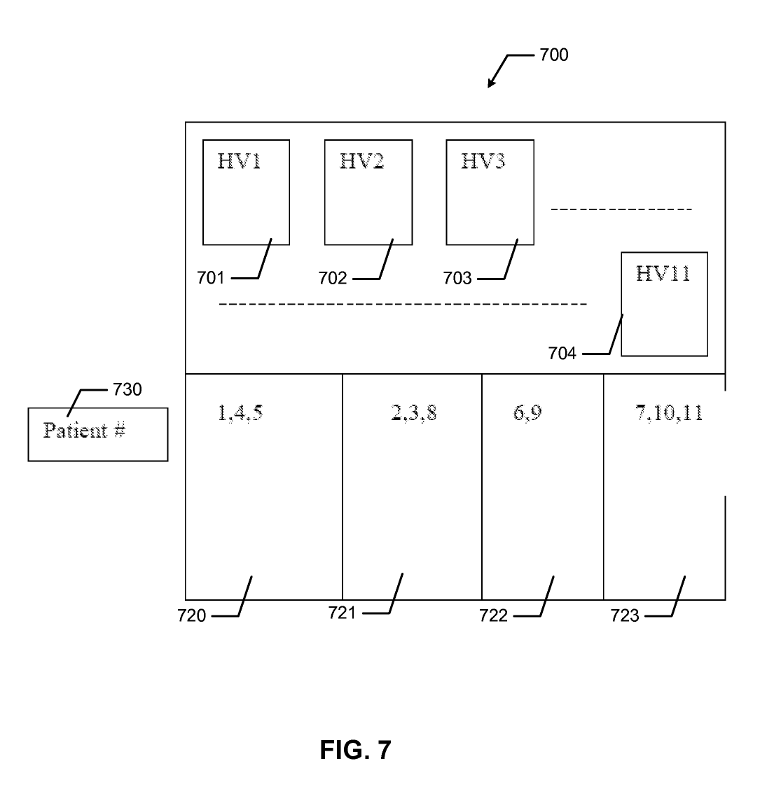

In the example depicted in FIG. 7, an interface 700 provides holistic views 701-704 and clustering 720-723 for a plurality of patients based on patient number 730. Using the interface, a user can cluster holistic views (HVs) 701-704 of eleven (11) patients into four (4) groups 720-723 based on one or more criterion. For example, patients 1, 4, and 5 are in a different cluster 720 than patients 2, 3, and 8. As shown in FIG. 7, HV(s) 701-704 can provide information to draw conclusion(s) and determine further action(s) based on visual depiction of the information and relationship(s) within the information (e.g., patient clustering). Holistic view clustering can also be used for ad hoc grouping of objects including patients, drugs, tests, diseases, severities, etc., during drug discovery and/or clinical trials, for example.

In many cases of drug discovery, tests can be evaluated to determine separation between a placebo and one or more drugs being evaluated. A distribution analysis (e.g., a one-time distribution, a longitudinal distribution over time, etc.) shown via a holistic viewer can be used to visualize placebo/drug distinction(s). The holistic distribution viewer can represent non-numerical data forms in their native data forms, and disease signatures can be obtained for those tests.

For example, a placebo group can be compared to a drug group to evaluate comparative effect. A separation metric shows test results that provide a best separation with imaging and non-imaging tests given patient, drug, and/or other constraints. Results derived from the separation metric and/or other metrics in the comparison can be used as feedback to advance and/or further refine drug development, for example. Characteristics of a placebo versus a drug compound can be visualized and evaluated on an individual and/or group basis, for example.

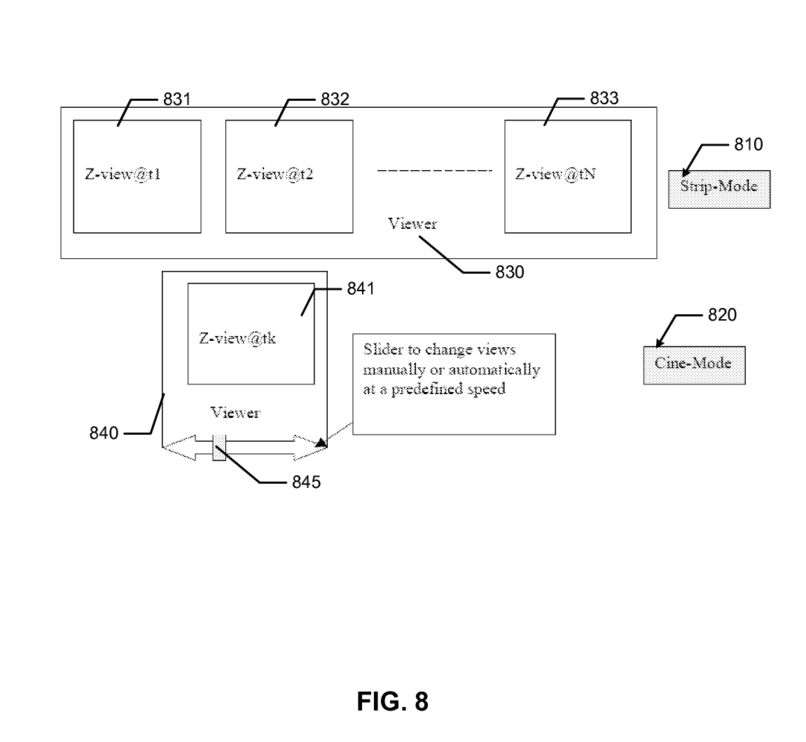

In certain examples, as depicted in FIG. 8, new time views can be provided for longitudinal analysis. Drug discovery can benefit from novel time trend representations. As shown, for example, in FIG. 8, longitudinal or Z-views can be presented in a “strip mode” 810 and/or a “cine mode” 820. In some examples, these representations can be performed on partial results using, for example, a filter, and/or on an entire data set.

The views 810, 820 shown in FIG. 8 provide alternative presentations of longitudinal data tracked over time. For example, the strip mode view 810 includes a viewer 830 including a plurality of longitudinal data views 831-833 over time. The cine mode view 820 includes a viewer 840 providing a longitudinal data view 841 and a control 845 (e.g., a slider) to change the view 841. The control 845 can be used to change the view 841 manually, automatically at a pre-defined or set speed, etc.

In certain examples, a holistic analysis and view can be applied to pharmacokinetics and/or pharmacodynamics. Pharmacokinetics (PK) characterizes absorption, distribution, metabolism, and elimination properties of a drug. Pharmacodynamics (PD) defines a physiological and biological response to an administered drug. PK/PD modeling establishes a mathematical and theoretical link between these two processes and helps to better predict drug action. Integrated PK/PD modeling and computer-assisted trial design via simulation are being incorporated into many drug development programs and are having a growing impact on drug development and testing.

PK/PD testing is typically performed at every stage of the drug development process. Because development is becoming increasingly complex, time consuming, and cost intensive, companies are looking to make better use of PK/PD data to eliminate flawed candidates at the beginning and identify those with the best chance of clinical success.

An analysis of PD/PK includes determining a maximum drug concentration (Cmax), a time to maximum concentration (Tmax), a minimum drug concentration or remains (Cmin), etc. For different drug components, interaction with a human body can be different. Multiple “runs” can be performed using one or more attributes including 1) across compound candidates, 2) across compound type, 3) across time, 4) in target disease affected organs, 5) in body distribution, 6) in specific organs that might be hurt, etc.

For example, a holistic viewer can be used for drug interaction studies. A goal of the interaction study is to determine whether there is any increase or decrease in exposure to a substrate in the presence of an interacting drug. If there is an interaction, implications of the interaction are assessed by understanding PK/PD relations. As an example, a holistic viewer can be used to figure out salient experimental runs by analyzing and visualizing the parameters with respect to one or more references. Parameters to analyze can include time-to-maximum (Tmax), maximum concentration (Cmax), average concentration, residual time, remains (Cmin), area under curve (AUC), etc. Drug exposure, expressed in terms of AUC (area under a drug plasma concentration-time curve), Cmax (maximum drug concentration in plasma), and/or an alternative parameter, for example, can be related to drug dose level and associated toxicological outcomes. Based on toxicokinetic data at a no-observed toxic effect dose, an acceptable exposure limit in humans can be defined.

Cmax indicates a maximum or “peak” concentration of a drug observed after its administration. Cmin represents a minimum or “trough” concentration of a drug observed after its administration and just prior to the administration of a subsequent dose. For drugs eliminated by first-order kinetics from a single-compartment system, Cmax, after n equal doses given at equal intervals can be represented by C0(1−fn)/(1−f)=Cmax, and Cmin=Cmax−C0, for example.

An area under a plot of plasma concentration of drug (not a logarithm of the concentration) against time after drug administration is represented by AUC. The area can be determined by the “trapezoidal rule”, for example. According to the trapezoidal rule, data points are connected by straight line segments; perpendiculars are erected from the abscissa to each data point; and the sum of the areas of the triangles and trapezoids so constructed is computed. When the last measured concentration (Cn, at time tn) is not zero, the AUC from tn to infinite time is estimated by Cn/kel. An elimination rate constant (kel) is a first order rate constant describing drug elimination from the body. Kel is an overall elimination rate constant describing removal of the drug by all elimination processes including excretion and metabolism. The elimination rate constant is the proportionality constant relating the rate of change drug concentration and concentration or the rate of elimination of the drug and the amount of drug remaining to be eliminated, for example.

The AUC is of particular use in estimating bioavailability of drugs, and in estimating total clearance of drugs (CIT). Following single intravenous doses, AUC=D/CIT, for single compartment systems obeying first-order elimination kinetics; alternatively, AUC=C0/kel. With routes other than the intravenous, for such systems, AUC=F·D/CIT, where F is the bioavailability of the drug. The ratio of the AUC after oral administration of a drug formulation to that after the intravenous injection of the same dose to the same subject can be used during drug development to assess a drug's oral bioavailability, for example.

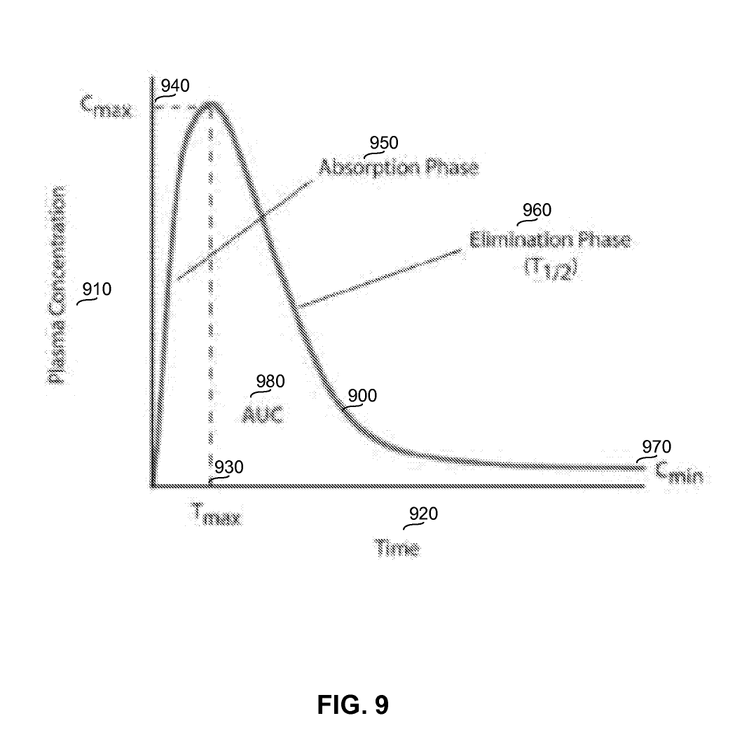

FIG. 9 illustrates an example PK curve 900 including parameters discussed above. As shown on the graph of FIG. 9, the curve 900 is plotted based on plasma concentration 910 versus time 920. At a time to maximum (Tmax) 930, a maximum concentration (Cmax) 940 is identified. Prior to achieving Cmax 940 at Tmax 930, a drug is in an absorption phase 950 in a patient. After Tmax 930, the drug is in an elimination phase 960 resulting in a drug residue or remains (Cmin) 970. Based on this information, an area under the curve (AUC) 980 can be determined

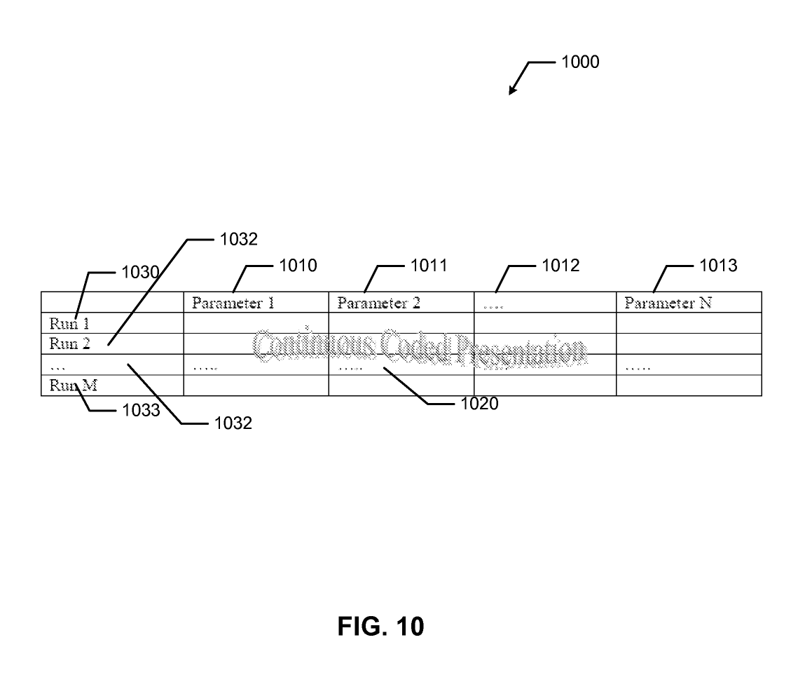

Holistic views can be created in a number of different ways. As illustrated, for example, in FIG. 10, a drug can be selected as a reference to analyze one or more parameters 1010-1014 of different drug interaction with the body including time-to maximum, maximum concentration, area under curve, and remains. The parameters 1010-1014 can be presented as a continuous color coded representation 1020 for easy visualization, for example. The continuous color coded representation 1020 can include a range of shades, degrees, and/or other color variations from one end of a spectrum to another (e.g., red is below normal, blue is normal, green is above normal, and values falling in between are associated with other colors along that spectrum), for example. The parameters 1010-1014 can be evaluated over multiple test runs 1030-1034, for example. Along with the drug development and clinical trial, the reference drug and key parameter(s) can be updated for a next round clinical trial and drug improvement, for example. A preferred or “ideal” candidate can be picked by visual comparison and/or by an appropriate criterion (e.g., a weighted score), for example.

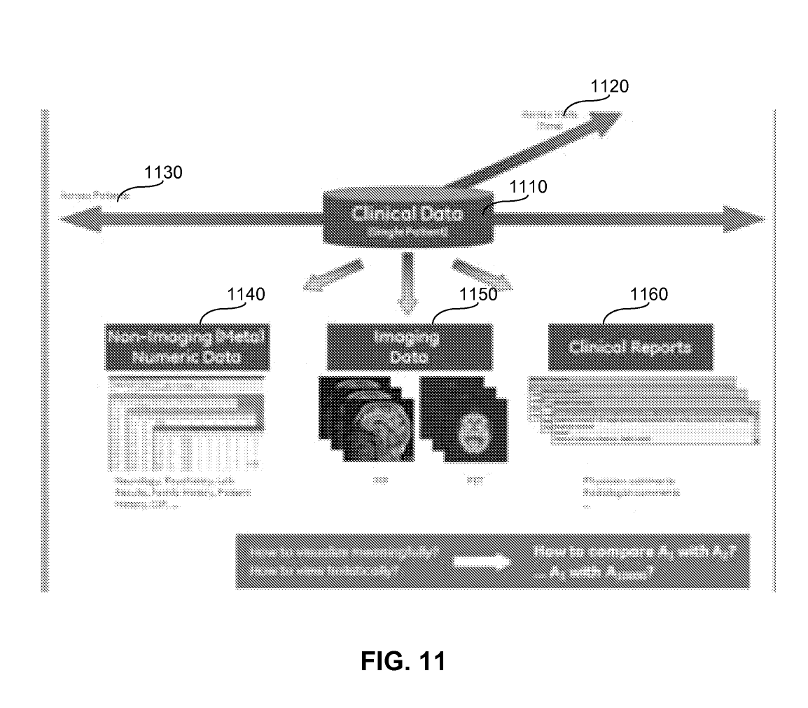

As demonstrated in the data flow 1100 of FIG. 11, clinical data 1110 can be aggregated for a single patient and/or multiple patients. The data 1110 can be gathered and/or compared across visits 1120 (e.g., over time), across patients 1130 (e.g., population-based comparison), etc. Data 1110 can include non-imaging numeric data 1140, imaging data 1150, clinical reports 1160, etc. Since non-imaging data 1140, imaging data 1150, and clinical reports 1160 can vary in content, format, etc., the disparate data can be compared via one or more holistic views, for example. For example, a holistic view can be used with disparate data to facilitate data mining, classification, data analysis for drug trials, drug discovery, candidate analysis, post-market surveillance techniques, etc. Holistic data analysis helps reduce siloed or separated data and facilitate comparison, for example.

Using a holistic analysis, data relating to one or more phases or stages of drug development can be reviewed in terms of deviation from an expected, “normal”, and/or other reference value. Using a graphical deviation-based analysis, abnormal and/or unexpected pharmaceutical results can be identified, for example. In certain examples, a deviation from a normal and/or expected behavior can be graphically represented such that each of a variety of disparate data types are visually represented according to a common scheme (e.g., a color-based variance from normal such that black is good, red is bad, etc.). Using a graphical (e.g., color-based) representation, varying types of data can be viewed and analyzed together.

In certain examples, a deviation score is calculated from underlying data values to determine a corresponding graphical indication for display. If a user desires to review underlying data values, the user can drill down through the graphical indicator to see the underlying values. However, a deviation from a normal, reference, or expected test result and/or property is depicted in an interface for the user. A degree or extent of deviation can be graphically depicted, for example. In certain examples, without displaying actual data values (but optionally making them available), hot spots or areas representing result(s) of interest can be visually depicted.

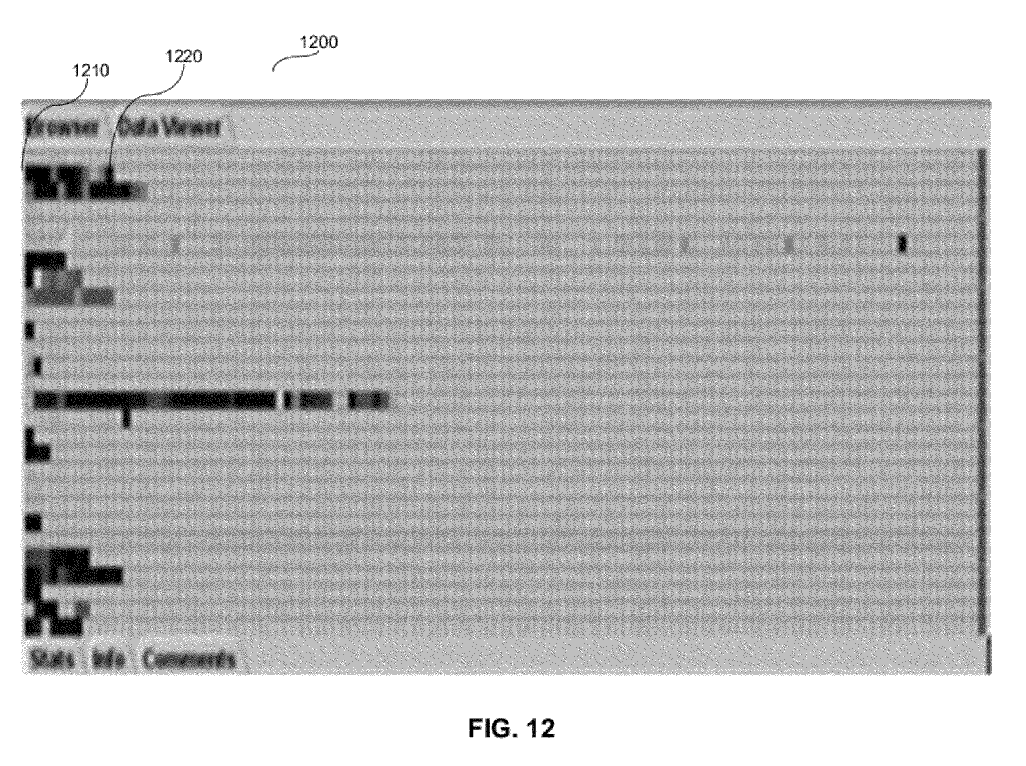

FIG. 12 depicts an example holistic viewer 1200 for a single patient at a certain point in time. The patient may be involved in a clinical trial and/or other drug test, for example. Using the holistic viewer 1200, a user can jump from test to test for the patient or other test subject, for example. As depicted in the example of FIG. 12, rows 1210 represent test categories, and entries 1220 correspond to different tests.

As in the example of FIG. 12, a color, for example, indicates a comparison to a value, such as a normal, reference, or threshold value (e.g., blue red, etc.). In certain examples, results are colored and/or shaded based on a number of standard deviations the result is away from a normal or reference result (e.g., one, two, three, etc.). In certain examples, both numeric test data and image results data (e.g., pixel/intensity comparison) can be illustrated via a graphical representation of deviation so that a user can see whether a result varies and by roughly how much (e.g., two standard deviations, five standard deviations, etc.).

In certain examples, a user can adjust a comparison value to vary what the patient/drug is compared against. Using a cursor and/or other indicator (e.g., a hand), a user can move over a displayed block and/or other displayed deviation indicator to view underlying test results.

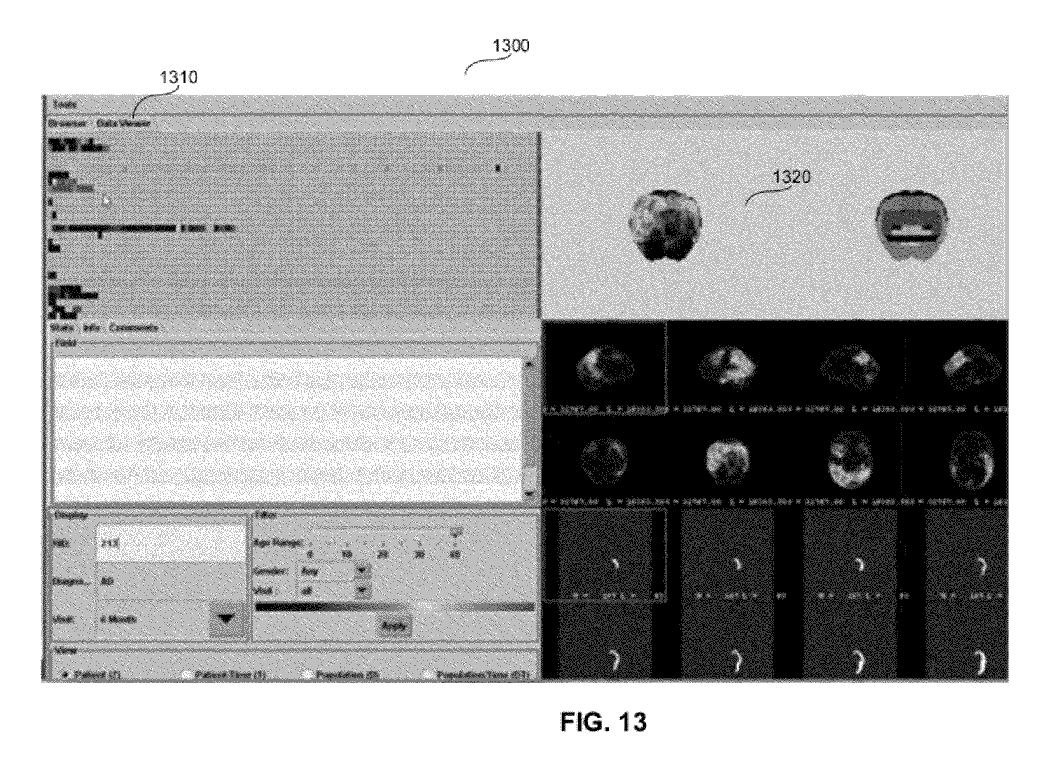

FIG. 13 illustrates an example holistic viewer interface 1300 to analyze a single candidate with respect to a population. The example holistic pharmaceutical viewer 1300 allows a user to focus on a particular candidate and select a particular point in time in the viewer 1300. As demonstrated in the example viewer 1300 of FIG. 13, a data viewer 1310 displays a visual indication of deviation for a particular result or value. By hovering over and/or selecting a particular result (e.g., using a cursor and a pointing device), underlying data can be reviewed. In the example viewer 1300, an image viewer 1320 provides color-coded images for the selected candidate. Thus, using the data and image viewers 1310, 1320 in the example interface 1300, a use can see clusters of tests and abnormalities on both test results data and images.

Using the example viewer interface 1300, a user can review results in the data viewer 1310 and/or image viewer 1320 to evaluate potential candidate(s) for a drug trial, drug trial result, etc. Instead of patient, could be tissue reaction to certain drug, etc. For particular result(s) of interest, a user can then zoom in to see further detail. A user can also look longitudinally at a progression of results and/or other data over time, for example. In certain examples, a user can compare a candidate's trends over time versus those of a population view the viewer 1300.

As demonstrated in the example of FIG. 13, numerous tests can be viewed in one interface based color-coding and/or other visual distinction of values. Using the representation, “normal” colors can be ignored to allow a user to focus on data whose color/representation indicates an abnormal, different, or unexpected result, for example. For example, a value represented as black may be a normal value, a value tending toward red may be higher than normal, and a value tending toward purple may be lower than normal.

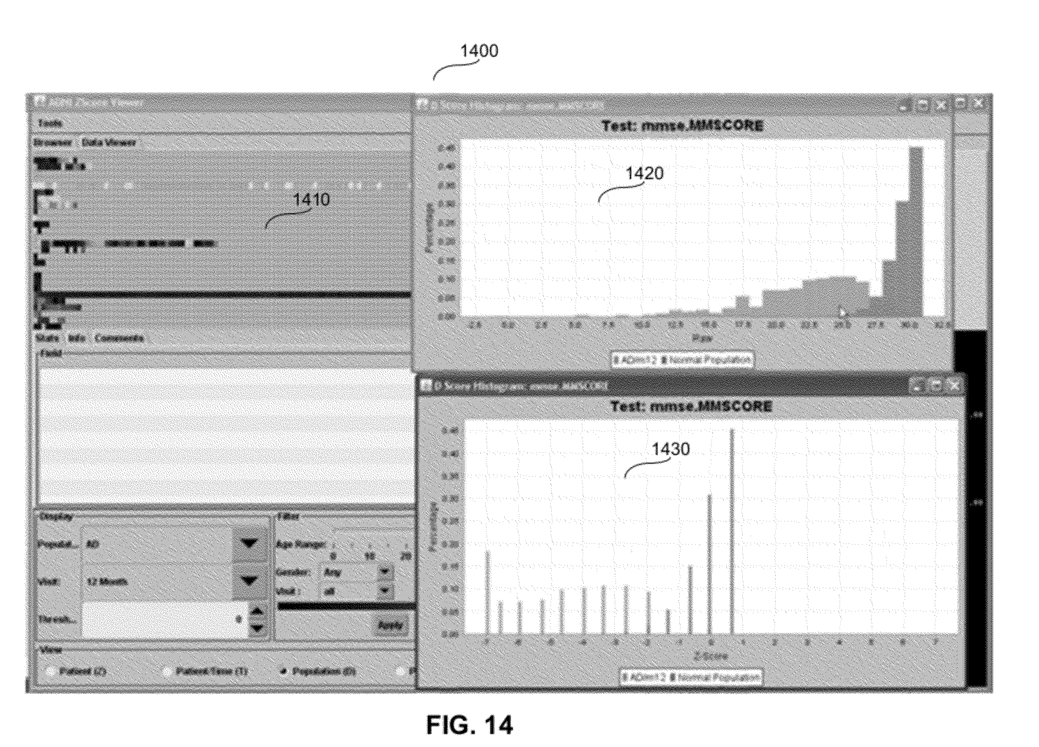

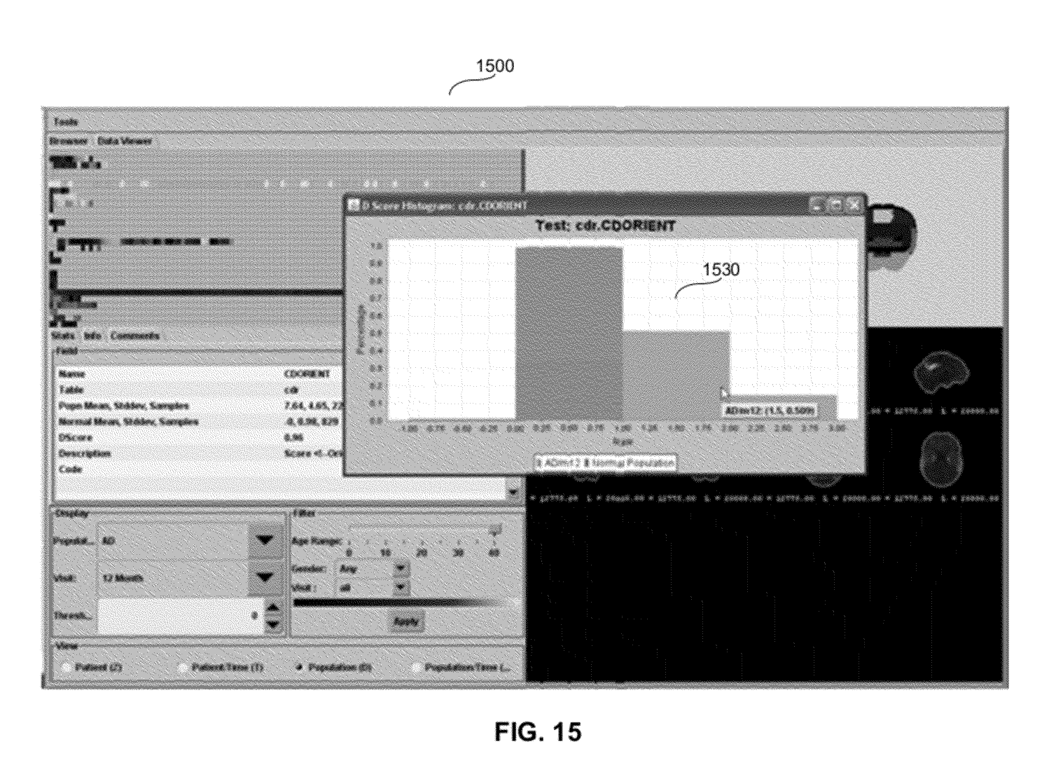

FIGS. 14-15 illustrate example pharmaceutical holistic viewers 1400, 1500 facilitating comparison between groups or populations. Color-coding and/or other graphical representation helps a user visually appreciate difference in populations based on test results, etc. For example, a blue group may represent a normal group, while a red group is an abnormal group. A bright yellow indicator may represent a complete separation between populations, for example. A color, shade, and/or intensity can provide a visual cue as to an extent and/or magnitude of deviation, for example. In certain examples, by positioning a cursor over and/or otherwise selecting a graphical representation of a test result and/or other data point, a user can retrieve additional information about the selected value or set of values. Such group to group and/or single to group analysis can be used to supplement or replace group data mining techniques, for example.

As shown in the example of FIG. 14, by selecting a displayed value in a data viewer 1410, a distribution of raw scores 1420 and/or a deviation score 1430 can be displayed for the data. The additional depictions 1420, 1430 can provide further graphical and/or alphanumeric information about a result, for example. A raw data graph 1530 in the example of FIG. 15 provides a further example of user interaction with and retrieval of information via an example holistic viewer 1500.

In certain examples, a population or group can be viewed over time (e.g., longitudinal. Using a longitudinal view, a user can see how a target group progresses over time compared to a control group, for example.

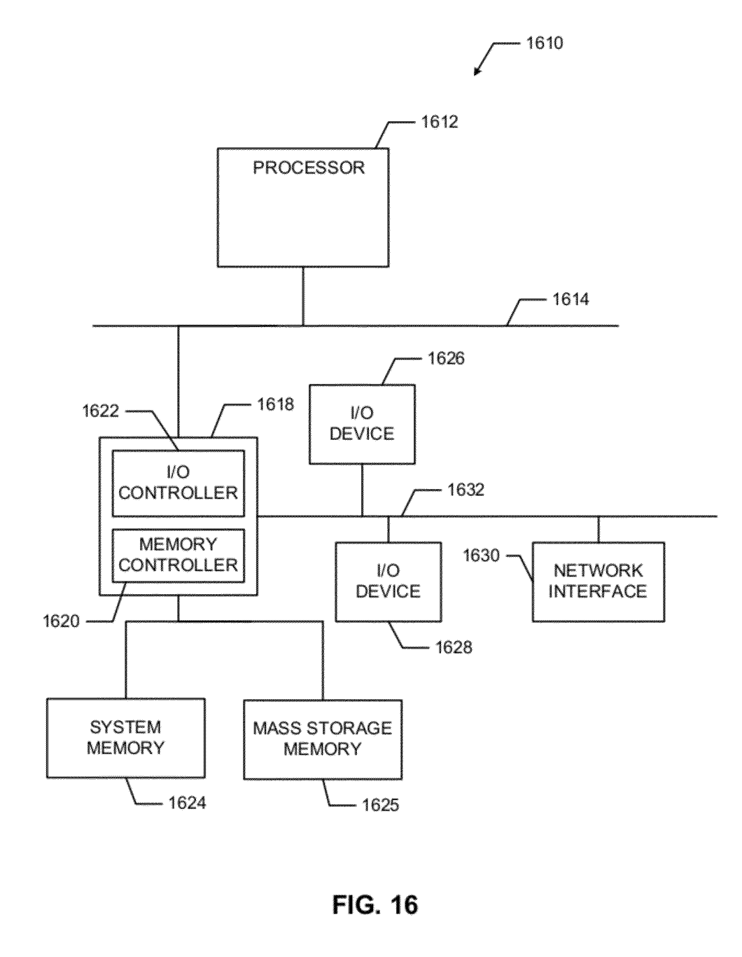

FIG. 16 is a block diagram of an example processor system 1610 that can be used to implement the systems, apparatus and methods described herein. As shown in FIG. 16, the processor system 1610 includes a processor 1612 that is coupled to an interconnection bus 1614. The processor 1612 can be any suitable processor, processing unit or microprocessor. Although not shown in FIG. 16, the system 1610 can be a multi-processor system and, thus, can include one or more additional processors that are identical or similar to the processor 1612 and that are communicatively coupled to the interconnection bus 1614.

The processor 1612 of FIG. 16 is coupled to a chipset 1618, which includes a memory controller 1620 and an input/output (I/O) controller 1622. As is well known, a chipset typically provides I/O and memory management functions as well as a plurality of general purpose and/or special purpose registers, timers, etc. that are accessible or used by one or more processors coupled to the chipset 1618. The memory controller 1620 performs functions that enable the processor 1612 (or processors if there are multiple processors) to access a system memory 1624 and a mass storage memory 1625.

The system memory 1624 may include any desired type of volatile and/or non-volatile memory such as, for example, static random access memory (SRAM), dynamic random access memory (DRAM), flash memory, read-only memory (ROM), etc. The mass storage memory 1625 may include any desired type of mass storage device including hard disk drives, optical drives, tape storage devices, etc.

The I/O controller 1622 performs functions that enable the processor 1612 to communicate with peripheral input/output (I/O) devices 1626 and 1628 and a network interface 1630 via an I/O bus 1632. The I/O devices 1626 and 1628 may be any desired type of I/O device such as, for example, a keyboard, a video display or monitor, a mouse, etc. The network interface 1630 may be, for example, an Ethernet device, an asynchronous transfer mode (ATM) device, an 802.11 device, a DSL modem, a cable modem, a cellular modem, etc. that enables the processor system 1610 to communicate with another processor system.

While the memory controller 1620 and the I/O controller 1622 are depicted in FIG. 16 as separate blocks within the chipset 1618, the functions performed by these blocks may be integrated within a single semiconductor circuit or may be implemented using two or more separate integrated circuits.

Thus, certain examples provide holistic visual systems, methods, and apparatus to process drug development data related to target and reference value(s) according to one or more metrics and provide output to a user for visual review and analysis. Conformity and/or deviation between a group of test data and a reference/control data set and/or another group of test data can be graphically provided to a user for holistic analysis, rather than a numerical result provided by computer data mining. For example, drug development and clinical trial data can be compared to reference drug and parameter data to better facilitate and/or adjust a next of clinical trial and drug improvement. Certain examples provide an additional technical effect of dynamic metric identification and data analysis to provide an integrated comparative visualization of an available body of drug development data to enable a user to arrive at a result and/or make a decision regarding a next step in a drug development process (e.g., drug discovery/exploratory research, pre-clinical research and development, clinical research and development (e.g., clinical trials), product approval, post-marketing, etc.).

Certain examples contemplate methods, systems and computer program products on any machine-readable media to implement functionality described above. Certain examples can be implemented using an existing computer processor, or by a special purpose computer processor incorporated for this or another purpose or by a hardwired and/or firmware system, for example.

One or more of the components of the systems and/or steps of the methods described above may be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device. Certain examples can omit one or more of the method steps and/or perform the steps in a different order than the order listed. For example, some steps/blocks may not be performed in certain examples. As a further example, certain steps may be performed in a different temporal order, including simultaneously, than listed above.

Certain examples include computer-readable media for carrying or having computer-executable instructions or data structures stored thereon. Such computer-readable media can be any available media that may be accessed by a general purpose or special purpose computer or other machine with a processor. By way of example, such computer-readable media can include RAM, ROM, PROM, EPROM, EEPROM, Flash, CD-ROM, DVD, Blu-ray, optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Certain examples can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Examples can also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain examples or embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A computer-implemented method for integrated quantifiable comparative analysis and decision support in a drug development process, said method comprising:
accessing data related to drug development;
pre-processing said data to prepare said data for measurement and analysis;
analyzing said data based on at least one of a plurality of different metrics, wherein each metric corresponds to a quantified variation between a first data set of results corresponding to an identified category in the drug development process, said first data set of results provided for comparison with a second data set of results corresponding to at least one other identified category in the drug development process;
aggregating at least some of said plurality of metrics to generate a visual representation representing an integrated comparative visualization for the identified category, said integrated comparative visualization enabling a user to observe an outcome represented by at least some of said plurality of different metrics considered collectively to generate a visual report.

2. The method of claim 1, further comprising:
displaying said data related to drug development;
providing a plurality of classes, each class representative of a pharmaceutical group; and
accepting user input regarding selection of a class matching said displayed data to classify said data.

3. The method of claim 2, wherein said pharmaceutical group comprises one of a patient cohort, a drug, a test, a disease type, and a disease severity.

4. The method of claim 1, wherein the integrated comparative visualization comprises a color-coded deviation map.

5. The method of claim 1, further comprising allowing the user to cluster a plurality of holistic patient data views based on a criterion.

6. The method of claim 1, wherein said first data set of results comprises placebo test results and wherein said second data set of results comprises drug test results and wherein at least one of said plurality of metrics comprises a separation metric to visualize a separation between placebo results and drug results.

7. The method of claim 1, wherein said visualization further comprises one or more time views for longitudinal analysis of said data.

8. The method of claim 7, wherein said time views are displayed to a user via at least one of a strip mode view and a cine mode view.

9. The method of claim 1, wherein said plurality of metrics include a pharmacodynamics metric and a pharmacokinetics metric to model clinical design to eliminate flawed clinical trial candidates and identify candidates with a better chance of clinical success compared to other available candidates.

10. The method of claim 9, wherein said pharmacodynamics metric and said pharmacokinetics metric are used to analyze a plurality of parameters including one or more of a maximum drug concentration, a time to maximum drug concentration, and a minimum drug concentration.

11. A holistic analysis and viewing system to support pharmaceutical drug development, said system comprising:
a standardizer to at least one of standardize and normalize data related to drug development;
a deviation analyzer to analyze said data based on at least one of a plurality of different metrics, wherein each metric corresponds to a quantified variation between a first data set of results corresponding to an identified category in the drug development process, said first data set of results provided for comparison with a second data set of results corresponding to at least one other identified category in the drug development process;
an output to aggregate at least some of said plurality of metrics to generate a visual representation representing an integrated comparative visualization for the identified category, said integrated comparative visualization enabling a user to observe an outcome represented by at least some of said plurality of different metrics considered collectively to generate a visual report.

12. The system of claim 11, wherein said output is to display said data related to drug development and provide a plurality of classes, each class representative of a pharmaceutical group, said system further comprising a user interface to accept user input regarding selection of a class matching said displayed data to classify said data.

13. The system of claim 11, further comprising an interface to allow the user to cluster a plurality of holistic patient data views based on a criterion.

14. The system of claim 11, wherein said first data set of results comprises placebo test results and wherein said second data set of results comprises drug test results and wherein at least one of said plurality of metrics comprises a separation metric to visualize a separation between placebo results and drug results.

15. The system of claim 11, wherein said visualization further comprises one or more time views for longitudinal analysis of said data.

16. The system of claim 11, wherein said plurality of metrics include a pharmacodynamics metric and a pharmacokinetics metric to model clinical design to eliminate flawed clinical trial candidates and identify candidates with a better chance of clinical success compared to other available candidates.

17. The system of claim 16, wherein said pharmacodynamics metric and said pharmacokinetics metric are used to analyze a plurality of parameters including one or more of a maximum drug concentration, a time to maximum drug concentration, and a minimum drug concentration.

18. The system of claim 11, wherein said data includes both image data and non-image data and wherein integrated comparative visualization allows a deviation comparison of both image data and non-image data.

19. A tangible computer-readable storage medium including executable instructions for execution using a processor, wherein the instructions, when executed, provide a holistic analysis and viewing system to support a drug development process, said system comprising:
a standardizer to at least one of standardize and normalize data related to drug development;
a deviation analyzer to analyze said data based on at least one of a plurality of different metrics, wherein each metric corresponds to a quantified variation between a first data set of results corresponding to an identified category in the drug development process, said first data set of results provided for comparison with a second data set of results corresponding to at least one other identified category in the drug development process;
an output to aggregate at least some of said plurality of metrics to generate a visual representation representing an integrated comparative visualization for the identified category, said integrated comparative visualization enabling a user to observe an outcome represented by at least some of said plurality of different metrics considered collectively to generate a visual report.

20. The computer-readable storage medium of claim 19, wherein said output is to display said data related to drug development and provide a plurality of classes, each class representative of a pharmaceutical group, said system further comprising a user interface to accept user input regarding selection of a class matching said displayed data to classify said data.

21. The computer-readable storage medium of claim 19, further comprising an interface to allow the user to cluster a plurality of holistic patient data views based on a criterion.

22. The computer-readable storage medium of claim 19, wherein said first data set of results comprises placebo test results and wherein said second data set of results comprises drug test results and wherein at least one of said plurality of metrics comprises a separation metric to visualize a separation between placebo results and drug results.

23. The computer-readable storage medium of claim 19, wherein said visualization further comprises one or more time views for longitudinal analysis of said data.

24. The computer-readable storage medium of claim 19, wherein said plurality of metrics include a pharmacodynamics metric and a pharmacokinetics metric to model clinical design to eliminate flawed clinical trial candidates and identify candidates with a better chance of clinical success compared to other available candidates.

25. The computer-readable storage medium of claim 24, wherein said pharmacodynamics metric and said pharmacokinetics metric are used to analyze a plurality of parameters including one or more of a maximum drug concentration, a time to maximum drug concentration, and a minimum drug concentration.

26. The computer-readable storage medium of claim 19, wherein said data is related to a phase of drug development, said phase including at least one of a pre-clinical research phase, a clinical research phase, and a post-marketing phase.
